(19) United States
(12) Patent Application Publication
(10) Pub. No.: US 2012/0215616 A1
(43) Pub. Date: Aug. 23, 2012

(54) SYSTEM AND METHOD FOR ADVERTISING LAST MINUTE AVAILABILITY OF SERVICES

(76) Inventor: Thomas Leach, San Diego, CA (US)

(21) Appl. No.: 13/030,930

(22) Filed: Feb. 18, 2011

(51) Int. Cl. G06Q 30/02

(52) U.S. Cl. 705/14.35

(57) ABSTRACT

A system for connecting businesses with a customer community stores business registration information associated with the businesses, including the type of service offered by each business, and customer registration information including services of interest and contact information. A server receives information from a business via a communication interface that an offer is available for a limited time at a discount price, and sends information on the offer to a plurality of customers for whom the offer is relevant, based on stored customer information. Interested customers receiving the offer reply to the offer through the system, the system sends the replies to the business, and the business is charged a predetermined fee for connecting the customers to the business based on the number of replies to the offer received by the business through the system.

### BACKGROUND

1. Technical Field

The embodiments described herein are related to communication systems for connecting customers and businesses.

2. Related Art

Conventionally, many businesses have had difficulties dealing with last minute cancellations. For example, consider a business such as a hair salon that schedules appointments for its services. If a customer cancels near the time of the appointment, the salon may have trouble filling the vacated appointment and may lose revenue as a result. Services do exist to help businesses increase traffic in general. There is of course traditional advertisement through print and other media. But the conversion rate for this type of advertising is low, difficult to ascertain, and it is also difficult to maintain any increase in business that may result. This type of advertising also does not help with last minute cancellations, which can be very costly to business and is not related to the volume of business. In other words, a business may have booked all its available appointments, reservations, or time slots for the week or month. Thus, business volume or traffic is not an issue. But if there is one cancellation per day that cannot be filed due to the last minute nature of cancellations, then the impact on the business can be significant.

Internet advertising is of course on the rise and there are numerous websites that attempt to deal with last minute availability. Most of these websites, such as Orbits.com, broker last minute deals on flights, hotel rooms, rental cars, or other services related to travel. But these sites do not generally deal with last minute cancellations. Rather, they deal with excess or unsold capacity.

As with everything else, the Internet has revolutionized the more conventional coupon idea. Sites like Groupon.com allow business to offer a large discount for products or services through online banner ads. But typically the entity that arranges the advertising takes a cut of the proceeds from the already discounted sales resulting from the advertisement. Thus, while the company may be able to satisfy its availability, it may sacrifice a large percentage of the usual revenue in order to do so. Further, such internet advertising or promotion often attracts customers who are unlikely to continue to patronize the business at non-discounted rates. And such services still do not address the last minute cancellation problem.

### SUMMARY

Customers register with a service and provide information including specific businesses from which they would like to receive offers. Businesses also register with service. Registered businesses indicate availability to the service in terms of offers. The service sends offers to the customers for whom the offers are relevant. Interested customers reply to the offers through the service. The service charges a fee to the business based on the number of replies.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an communication system in accordance with one embodiment;

FIG. 2 is a flow chart illustrating a method of communicating offers from a business to a set of customers in accordance with an example embodiment;

FIG. 3 is a flow chart illustrating an example method for business registration with the system of FIG. 1 in accordance with an example embodiment;

FIG. 4 is a flow chart illustrating an example method for customer registration with the system of FIG. 1 in accordance with an example embodiment;

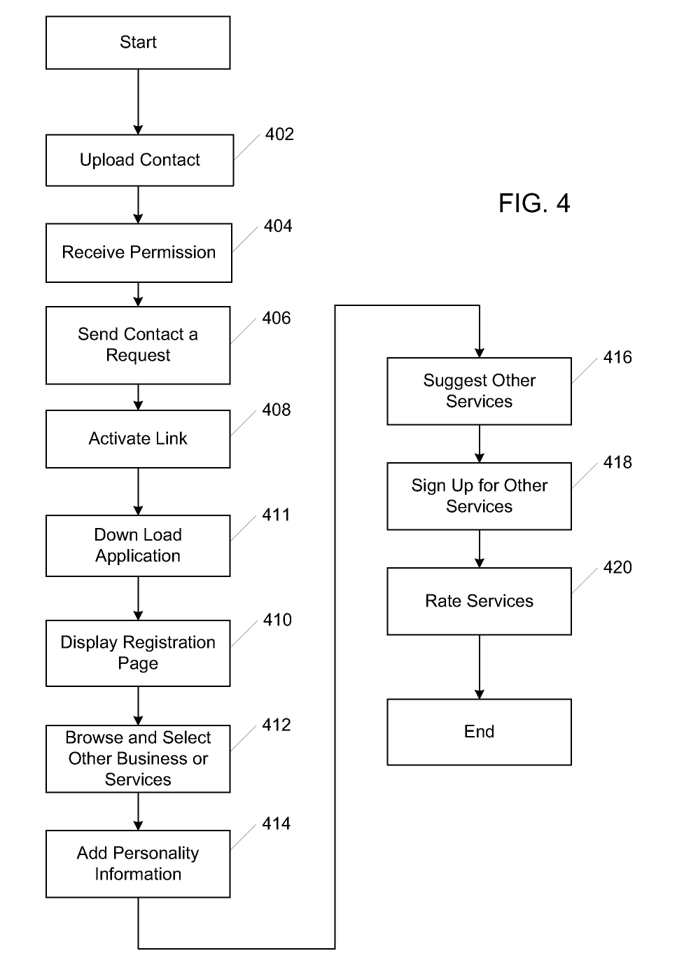

FIG. 5 is a flow chart illustrating another example method for customer registration with the system of FIG. 1 in accordance with an example embodiment; and

FIG. 6 is a diagram illustrating a user interface in accordance with another example embodiment.

### DETAILED DESCRIPTION

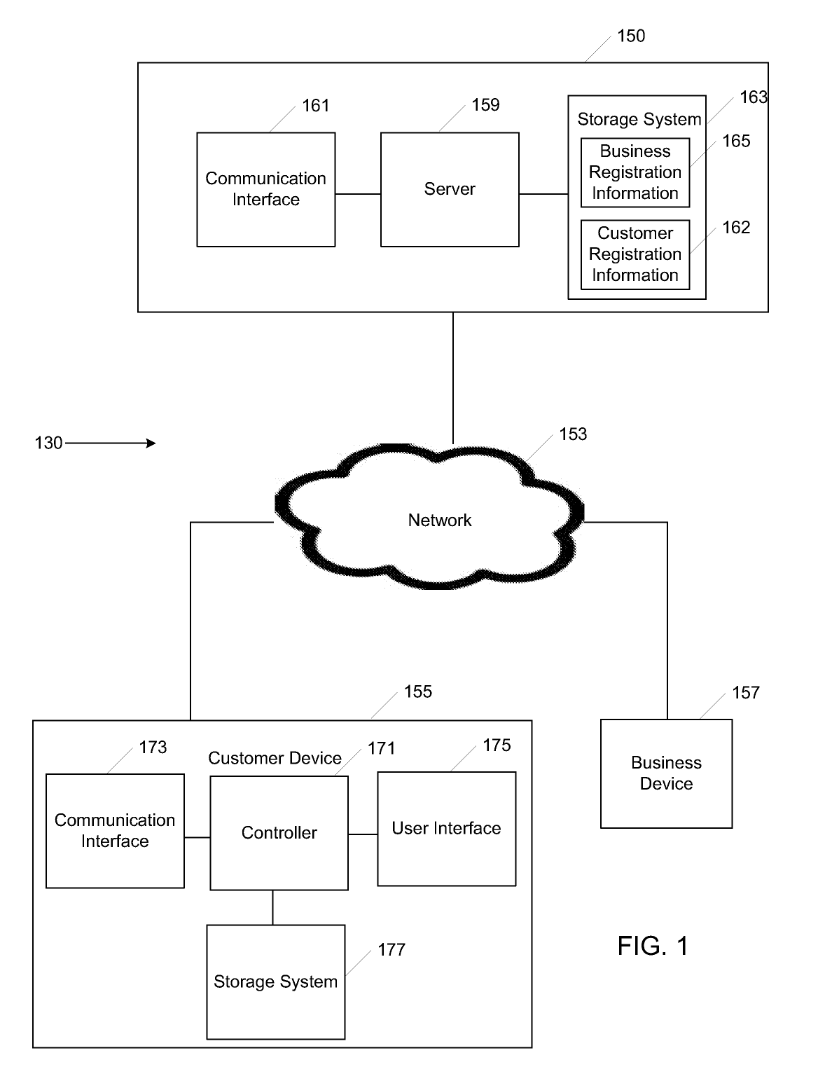

FIG. 1 is a diagram illustrating an example embodiment of a communication system 130 configured in accordance with the systems and methods described herein. The communication system 130 facilitates improved communication between businesses and customers and helps businesses address the problem of last minute cancellations. For example the communication system 130 allows businesses to quickly notify relevant customers of availability of services and allows relevant customers to quickly respond to the notifications. In addition, as explained below, system 130 can also help facilitate improved internet search capability and social interaction.

The communication system 130 comprises system 150, network 153, customer device 155, and business device 157. For the purpose of explanation, the system 150 can be referred to as a communication service or simply as a service. It will be appreciated that the properties and activities attributed to the service can describe the system 150. In general, the system 150 advertises offers to relevant customers and connects interested relevant customers to businesses.

System 150 can be communicatively coupled to a network 153. The network 153 can comprise one or more wired or wireless networks, e.g., the internet, PTSN, wireless networks, other networks or a combination of any of these. In general, the network 153 can be configured to facilitate communication between the system 150, the customer device 155, and the business device 157.

Customer device 155 can also be communicatively coupled to the network 153. The customer device 155 can be a communication device such as a mobile phone, PDA, netbook, desktop, or laptop. Other devices can also be used. In general, the customer device allows the customer to receive offers from the system 150, to respond to the offers, and to communicate with the business device 157.

The business device 157 can also be communicatively coupled to the network 153. The business device 157 can be a device similar to the customer device 157. In general, the business device 157 allows a business to notify relevant customers of offers through the system 150 and to communicate with interested relevant customers.

Returning now to the system 150, the system 150 can comprise a server 159, a communication interface 161, and a storage system 163. The server 159 can be communicatively coupled to the communication interface 161 and to the storage system 163. The server 159 can act as a controller for the communication interface 161 and the storage system 163. In one embodiment, the server is implemented on one or more processors configured to execute instructions for carrying out the functionality described in relationship to the system 150.

The communication interface 161 can be used by the server to communicate over the network 153 with the customer device 155 and the business device 157. For example, the server 159 can register both customers and businesses via interface 161, receive offers from the business device 157 via the communication interface 161, and send offers to the customer devices 155 of one or more relevant customers via the communication interface 161. In one embodiment, the communication interface 161 comprises a transceiver or other device for communicating over the network 153.

The storage system 163 can comprise business registration information 165 and customer registration information 167. As described in greater detail below, both businesses and customers can register with the service in order to participate. The registration information for both the businesses and customers can be stored in the storage system 163. The server 159 can be configured to use the registration information stored in the storage system 163 to facilitate the functionality described herein. For example, the server 129 can use the registration information to determine one or more relevant customers for a particular offer or to facilitate a recommendation. In one embodiment, the storage system 163 can be implemented as a non-transitory computer-readable medium. The storage system 163 can also comprise instructions that, when executed by the server 159, cause the system 150 to perform the functionality described with respect to the system 150.

Returning now to the customer device 155, the customer device 155 can comprise a controller 171, a communication interface 173, a user interface 175, and a storage system 177. The controller 171 can be communicatively coupled to the communication interface 173, user interface 175, and storage system 177. The controller 171 can control the communication interface 173, the user interface 175, and the storage system 177. In one embodiment, the controller 171 is implemented on one or more processors configured to execute instructions for carrying out the functionality described in relationship to the system customer device 155. The communication interface 173 and storage system 177 can be implemented as described above with respect to the communication interface 161 and storage system 163.

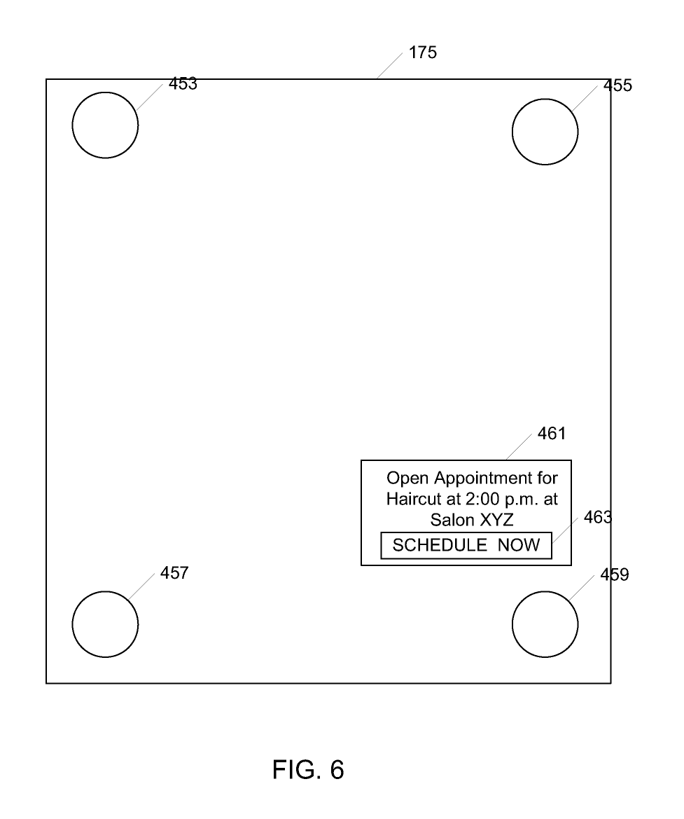

The user interface 175 can facilitate communication between a customer (not shown) and the customer device 173. For example, the user interface can comprise a touch screen, keypad, keyboard, speaker, microphone, camera, display or other input or output device capable of capturing information from a user or outputting information to a user. One particular example of a touch screen is explained in greater detail with respect to FIG. 6.

It will be appreciated that the business device 157 can also comprise a controller, communication interface, user interface, and storage system as described with respect to the customer device 155.

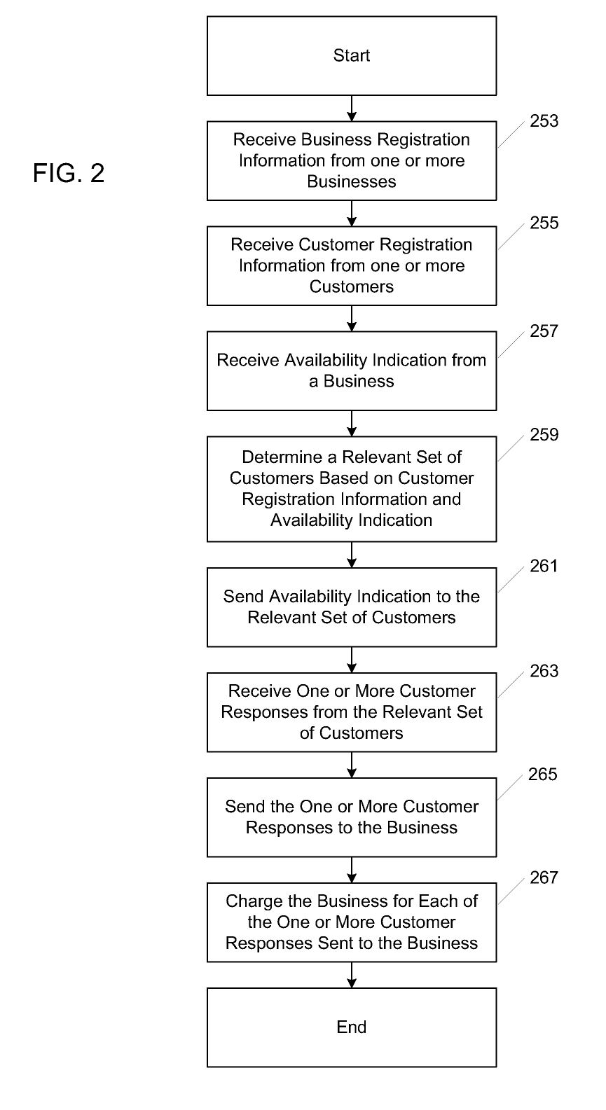

FIG. 2 illustrates an example method for improved communication between businesses and customers in accordance with one embodiment. The method can, for example be performed by the system 150. At step 253, the service receives business registration information from one or more businesses. For example, an owner of a hair salon can use a business device to transmit registration information to the service. The service then receives and stores the registration information. The business registration information can include many types of information. For example the business registration information can include a name of the business; its location; its contact information, e.g., telephone numbers or e-mail addresses; information on the type of services offered by the business, e.g., food, medical services, hair styling, or air travel; information on the specific services that are subject to an offer, e.g., price, description, or scheduling information; target demographic for customers; information on specific products or services, e.g., description, price; billing information, e.g., business account or credit card number; or other information. In one embodiment, the business registration information can also include contact information for customers of the business. Business registration is described in detail below.

Continuing at step 255, the service receives customer registration information from one or more customers. This can occur in several ways. As described above, in one embodiment, the business registration information can include customer contact information. The service can therefore request the permission of participating businesses to contact the customers in order to invite them to participate in the service. For example, the contact information can include a phone number or e-mail address. The service can then send a communication such as a text message or e-mail to the customer. The communication can include a link to a website provided by the service. The website can be used to input customer registration information that is sent to the service. In another embodiment, the communication can provide a link or instructions for downloading an application that can be used to input customer registration information that is sent to the service. This is described in more detail below.

In another embodiment, the customer can provide customer registration without prior solicitation through the service. For example, the customer can visit the website or download the app without prior contact from the service or in response to communications from the business rather than from the service. Alternatively, a customer can send a message, such as a text message or email, to a preferred number, address, etc., in order to automatically register with the service. This is also described in detail below.

The customer registration information can include, for example, identifying information, e.g., a name or location; demographic information, e.g., gender or age; contact information, e.g., telephone numbers or e-mail addresses; information on the type of services in which the customer may be interested, e.g., food, medical services, hair styling, or air travel; information on specific businesses in which the customer is interested, e.g., names of businesses or information identifying a particular franchise of a business; information relating to specific offers the customer is interested, e.g., days of the week on which the customer is available, destinations, or times of day; or other information. In one embodiment, the customer registration information can include an indication of the manner in which offers are matched to the customer, e.g., only offers from selected businesses or offers from any business for selected categories of goods or services.

Continuing at step 257, the service receives an availability indication from a business device 157. The availability indication can also be referred to as an offer. The offer can include information about a specific product or service. For example, the offer can indicate that a particular business, e.g., Salon XYZ, has an opening at a particular time on a particular day, often the same day, with a particular stylist. In another example, the offer can indicate that an airline, e.g., ABC Airlines has a seat available on a particular route at a particular time. In one embodiment, the offer can also include pricing information. For example, the offer can include an absolute price to be charged for the good or service. In another example, the offer can include a relative discount on the good or service, e.g., 20%, 50%, etc. off. Other types of information, such as a description of a good or service can be included in the offer. The offer can also include identifying information for the business such as a name or other identifier.

In one particular implementation, the discount price is always 50% or some other set percentage. This discount rule can be conveyed with the offer. Alternatively, as explained below, since the customers can have complete control over what offers they received and from what business, the discount rate can simply be known in advance, e.g., it can simply be known that each offer is for 50% off. Thus, the customer will know they are receiving an offer for a last minute 50% discount for a service for which they indicated they would be interested in receiving such offers.

Continuing at step 259, the service determines a set of relevant customers for a particular offer based, at least in part, on customer registration information for one or more customers. This can be done in several ways. In one embodiment, the service determines the set of customers who have opted to receive offers from the particular business who provided the particular offer. For example, if Salon XYZ provides an offer, the service can determine that the set of relevant customers is all customers who have opted to receive offers from Salon XYZ.

In another embodiment, the service can determine a set of relevant customers based on the type of good or service subject to the offer. For example, if QRS Mechanics provide an offer on an oil change, the service can determine that the set of relevant customers includes all customers who have selected to receive offers on oil changes.

It will be appreciated that a combination of these two approaches, selection based on the offering business and selection based on good or service type, can be combined. For example, the service can determine that the set of relevant customers is the set of customers who have both selected to receive offers from a particular business and selected to receive offers for the type of good or service subject to a particular offer. Alternatively, the service can determine that the set of relevant customers includes customers that have either selected to receive offers from a particular business or selected to receive offers for the type of good or service subject to a particular offer.

In another embodiment, the service can also use other customer registration information in order to select a set of relevant customers. For example, the customer registration can include location information. In some embodiments, the location information can be a region of interest. For example, a customer can indicate that they are only interested in receiving offers for goods or services within a certain distance of an address, e.g., a home or work address. The service can therefore exclude customers from the set of relevant customers if the goods or services subject to the offer are not available within the region of interest.

In another embodiment, as explained in more detail below, the location information in the customer registration information can be updated dynamically. For example, if the customer device uses a location service, e.g., GPS, contemporaneous location information from the device can be used in determining the relevancy of the customer. In one example, the service can provisionally determine that a particular customer is relevant to an offer. After this provisional determination, the service can request current location information from the customer device. The customer device can then respond with the current location information. The service can then use the current location information to make a final relevancy determination. For example, if the good or service is being offered more than a certain number miles away, e.g., 1, 5, or 10, the customer can be determined to not be relevant to the offer. In one embodiment, the current distance threshold can be selected by customers and can be part of the customer registration information. In another embodiment, the customer device can be configured to periodically send current location information to the service. The service can then use the current location as described above.

In another embodiment, the service can use other types of information in the customer registration information to determine the relevance of customers to an offer. As described above, the customer registration information can contain scheduling information for customers. For example, a customer can select to receive offers for goods or services that are offered at particular times. Thus, in one example, a customer can select to only receive offers from particular businesses or for particular goods or services after 3:00 p.m. on weekdays. Based on this information, the server can determine that the customer is not relevant to a particular offer for a good or service that is only available before the specified time. Other types of customer registration information can also be used for determining relevance, e.g., customer specified destination for air travel or customer specified discount thresholds.

Continuing at step 261, the service sends the offer to the customer devices of the set of relevant customers. In one embodiment, this can be accomplished by a push operation. One example of how a customer can interact with a particular offer at the customer device is described with respect to FIG. 6. In one embodiment, information relevant to the offer is presented to the customer via the user interface of the customer device. The user interface also provides a way for the customer to respond to the offer. For example, the user interface can have a button or link that can me manipulated in order to respond to the offer.

Continuing at step 263, the service receives responses to an offer from the customer devices of the set of relevant customers. Positive response can be handled in several ways. In one embodiment, the response is a phone call from, e.g., the customer device to a phone number associated with the service. For example, the button or link provided by the customer device for responding to the offer can be configured to place a call from the customer device to the service when actuated. In one embodiment, the number used or other information accompanying the call contains an indication of the offer to which the customer device is responding.

In another embodiment, the response received by the service is not a phone call. Rather, the response is a message containing identification information for the costumer and the offer to which the customer is responding. In this embodiment, the button or link provided by the customer device for responding to an offer can be configured to send the described message to the service. In one embodiment, the button can be configured to place a phone call directly to the business providing the offer in addition to sending the message to the service.

Continuing at step 265, the service sends the one or more responses from customers to the business that provided the offer to which customers are responding. In one embodiment, this comprises connecting a phone call from the responding customers to the business. In another embodiment, this comprises sending the response message from the customers to the business.

Continuing at step 267, the service charges the business based on the responses sent from the service to the business. For example, the service can charge the business a fixed amount for each response sent to the business. In an alternative embodiment, the service can charge an amount for each response that changes based on the number of responses. For example, a first amount of responses, e.g., 10 or 20, can be charged at a first price while additional responses are charged at a second price. In another embodiment, the service can charge a flat fee for sending the offer and receiving responses regardless of the number of responses.

Obviously, more than one customer may respond to an offer, but only one can actually fill the last minute opening; however, each customer that responds is a good lead for the business. Thus, once the cancellation is filled, i.e., by the first to respond to the offer, the business can still offer to set up appointments for subsequent customers that respond and offer a discount, e.g., 25% off instead of 50%.

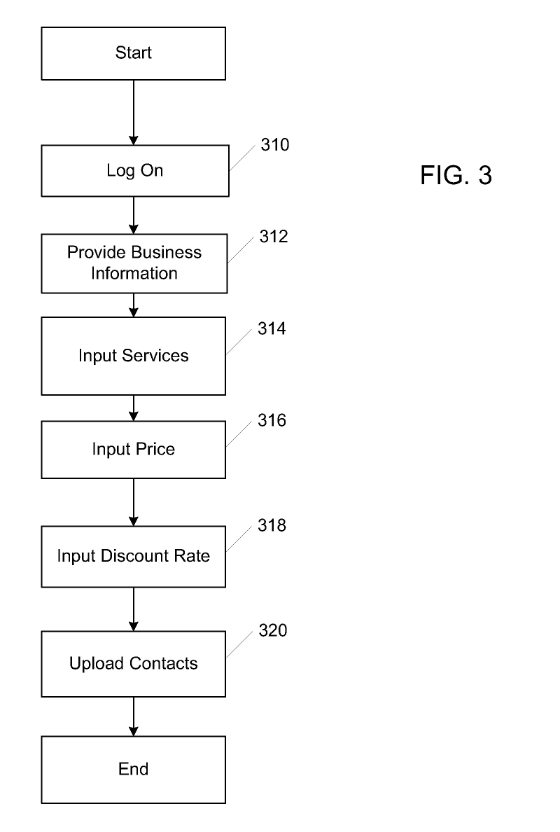

FIG. 3 is a flow chart illustrating an example process by which a business can register and make certain services available at a discount to its customers or potential customers. First, in step 310, a business can log onto a registration web site, e.g., hosted by server 159. The business can then input information such as business name, address, and type of business in step 312. In step 314, the business can then input what service they would like to make available when they have last minute cancellations at a discount. In step 316, the business can then input pricing information for the services indicated in step 314.

In certain embodiments, the business can then input a discount rate in step 318. In other embodiments, the discount can be predefined, e.g., 50% off. This can be preferable, because it provides uniformity. Thus, whenever a customer receives a notification of an opening, they will automatically know the discount rate. Otherwise, a discount rate will need to be communicated for each service and each business, which can complicate matters and reduce participation, especially if a significant number of businesses input a marginal discount. Accordingly, some control and preferably uniformity should be implemented with respect to the discount rate.

In step 320, the business can then upload their contact database, which can include contact information for their customers. This way, as explained below, the customers can be invited to register to receive notification of last minute cancellations and discount opportunities.

It should be noted that once server 159 has the customer contact information, then server 159 can cause those customers to receive an email, text message, etc., whenever a last minute cancellation has created availability for a services included in the services input in step 314; however, it can be preferable for the customers to actually register themselves and indicated which services they are interested in, what times, days of the week, they would be interested, etc. Customer registration can be accomplished via a variety of methods.

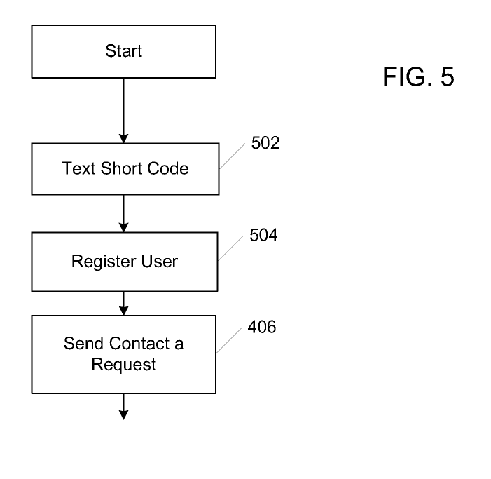

For example, FIG. 5 is a flow chart illustrating one example method for customer registration. In the example of FIG. 5, a contact is first uploaded from a business in step 402 as described above. In step 406, an invitation or request can be sent to the contact. For example, if the contact information uploaded in step 402 includes a cell phone number, then a text message or email can be sent to the contact's cell phone, alternatively, an email can be sent to the user's regular email account, a message can be posted on their Facebook or other social network page, they can be tweeted, etc., depending on what contact information is available.

In certain embodiments, permission can be requested from the business in step 404 before sending the contact a request in step 406.

The request sent in step 406 can include an explanation that the contact has been registered with the service so that they are aware. As explained below, it can also include a link that will either automatically download an application to their cell phone, that can take them to an, e.g., website hosted by system 150 where they can download the application, or both. Moreover, the request can also or instead include a link to a registration site, e.g., hosted by system 150 where the contact can provide further registration information.

Once the contact activates the link, or otherwise responds to the request, the application, widget, etc., can be downloaded to their cell phone in step 411. This can happen automatically depending on the embodiment, especially where the contact is responding from their cell phone. But even if the contact is not using their cell phone to respond, system 150 can still automatically push the application to the contact's cell phone provided the contact's cell phone information is known to system 150.

Alternatively, a registration page can be displayed to the contact in step 412. When the registration page comes up, it can include instructions for how to download the application that the contact can follow.

At this point, the contact will be registered for services from at least one vendor; however, the contact can then browse and select other business and services for which to sign up for notices in step 414. Additionally, the user can, and preferably will provide further personal information such as demographics, likes and dislikes, time and day of the week availability for different services, favorite music, favorite television shows, favorite movies, favorite foods, favorite sports teams, favorite books, and other favorites, preferences, etc. The demographic information can include, age, sex, weight, hair color, eye color, etc. The more information provided the better, and system 150 can be configured to gather almost any information from each contact, to the extent the contact is willing to provide it.

In step 416, system 150 can be configured to use the information provided, including the services the contact has already selected to suggest further services that the contact may be interested in. In certain embodiments, system 150 can also use data provided by other contacts to determine services to suggest. For example, as explained below, system 150 can be configured to generate a personality graph for each user based on their selected services, and other interest, etc., provided in the personal information. The personality graph can be a graphical representation of the contact's interest and can provide an easy way to evaluate similarities in the personality graphs of the various contacts in order to identify other services that may be of interest; however, other forms of analytics can be run on the data to identify trends, similarities, overlaps, relations, etc., which can be used to suggest further services in step 416.

In step 418, the user can then sign up for any suggested or additional services.

In certain embodiments, the user can also rate services or businesses in step 420. This type of information can also be used by system 150 to identify similarities or potential likes and dislikes among the contacts.

Alternatively, a potential contact can simply log onto system 150 and register without having received a request or invitation to do so.

FIG. 5 is a flow chart illustrating another example method for registering a contact in accordance with another embodiment. In this example, each business can be given, e.g., a sticker that they can place in their window or some other type of display that they can display in their business and that informs customers and passersbys that they are part of the service offered by system 150. The sticker or display can include a number that the customers or others can call or text. For example, the display can include a short code that the customers can text. Once the customer texts the code or number in step 502, they will automatically be signed up for alerts from that business in step 504.

In certain embodiments, once the user has been signed up for alerts from the particular business, system 150 can send them a request or invitation (step 406) and the customer can register as described above, provided they are not already registered. If the customer is already registered with system 150, then their profile can simply be updated to add the new business. In certain embodiments, however, a message can still be sent to the customer inviting them to log on and update their profile. New suggested services based on the addition of the business for which they just registered can also be provided.

In certain embodiments, system 150 can host a social networking site or environment that allows users, e.g., contacts, customers, etc., to publish all or some of their profile so they can see what services other users are signed up for and allow others to see their services, preferences, favorites, personality graphs etc. This aspect is described in more detail below.

First, however, FIG. 6 is a diagram illustrating an example icon for an application that can be downloaded to a user's cell phone or other mobile device, such as a Smartphone, tablet deice, reader, etc. Thus, the icon can be the user interface 175 of the costumer device 155. In one embodiment, the user interface 175 can be implemented on a touch screen. An application or other software operating on the customer device provides the functionality for the touch screen.

As shown, a notification indicator can be shown in each of the four corners of the icon 175. In one embodiment, each of the notification indicators 453, 455, 457, and 459 represents a different category of businesses, goods, or services for which the customer using the customer device has selected to receive offers. For example, the indicator 453 may correspond to travel (e.g., plane tickets). The indicator 455 may correspond to food (e.g., restaurants). The indicator 457 may correspond to entertainment (e.g., movie tickets). The indicator 459 may correspond to health (e.g., hairstyling or dentist appointments). In one embodiment, the user can select the types of categories associated with each notification indicator.

But it is important to remember that the user is not just signing up, e.g., for notifications of air flights, hotel reservations, restaurant openings, etc. rather, the user is signing up for very specific services, from very specific business. Thus, if the user has selected that indicator 453 will be associated with health care, then the user will know that when a notification 453 appears, it will be in relation to their doctor, their dental hygienists or dentist, their massage therapist, etc. Moreover, the indication will instantly inform the user that their, e.g., health care provider has an appointment, likely that day, at a time the user indicated they would be interested, and at a discount, e.g., half off. This makes it likely that the user will respond and contact the business, allowing the business to fill the last minute vacancy or cancellation.

In certain embodiments, each indicator 453, 455, 457, and 459 can be associated with a single business. In others, at least some of the indicators can be associated with a category, such as the health care example provided above.

Thus, when offers are received at the customer device, user interface, or icon 175 alerts the customer. For example, the appropriate indicator 453, 455, 457, and 459 corresponding to the category of a received offer may blink, change color, or otherwise communicate that a new offer has arrived. Specifically, in certain embodiments, a number corresponding to the number of offers can appear over the appropriate indicator. So for example, if the user has an offer from his or her dentist, a “1” can appear over indicator 453. If the user has an offer from both his or her dentist and massage therapist, then a 2 can appear over indicator 453.

In one embodiment, the user can review the received offer by pressing on, or otherwise selecting, activating, etc., the appropriate notification indicator. In response to this selection the user interface displays information related to the offer. One such display is represented by block 461. As shown, block 451 comprises information related to the offer as well as a button 463 for responding to the offer. The button 463 can be used as described with respect to FIGS. 2 and 3. While the user interface 175 of FIG. 6 has been described in relation to a touch screen, other types of displays and interfaces may also be used.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system for connecting businesses with a customer community, comprising:
a communication interface;
a storage system configured to store business registration information for a plurality of business, the business registration information including an associated service, a location, price information associated with the service, business account information, and business contact information; and customer registration information for a plurality of customers, the customer registration information including services of interest; business of interest information, customized notification information, demographic information, and customer contact information;
a server coupled with the storage system and the communication interface, the server configured to:
for each of the plurality of customers receive an indication of particular types of services and specific businesses that offer the services and for which the customer is interested in receiving notices of limited time offers for the indicted services from the indicated businesses;
storing the information received from the plurality of customers and customer registration information in the storage system;
receive an indication from a business via the communication interface that a service is available for a limited time and a discount price that is included in the price information;
push an indication out to a plurality of customers via the communication interface based on the service of interest and business of interest information included in the customer registration information associated with each of the plurality of customers and using the customer contact information for each of the plurality of customers;
receive a communication from one of the customers intended for the business via the communication interface;
charge the business a predetermined fee for connecting the customer to the business using the business account information; and
connect the customer with the business using the business contact information.

2. The system of claim 1, wherein the customer contact information for each of the plurality of customers includes a telephone number associated with each customer's mobile device, and wherein the server is further configured to download an application to a plurality of mobile devices associated with the plurality of customers.

3. The system of claim 2, where pushing the indication out to the plurality of customers comprises pushing a notification out to the application downloaded on each of the customer's mobile devices.

4. The system of claim 1, wherein the customized notification information comprises at least one of days of the week on which the associated customer would be interested in a particular service.

5. The system of claim 1, wherein the demographic information comprises at least one of age, residence, sex, weight, race, job, and income.

6. The system of claim 1, wherein the customer registration information includes preferred travel destinations and travel times.

7. The system of claim 5, wherein the customer registration information includes music preferences, movie preferences, and other media content preferences.

8. The system of claim 1, wherein the customer registration information includes social networking account information.

9. The system of claim 1, wherein the server is configured to build a psychographic profile for a customer based on an analysis of the customer registration information for the customer.

10. The system of claim 1, wherein the server is further configured to build the psychographic profile for the customer based on a comparison of the customer information for the customer with customer information for other customers.

11. The system of claim 1, wherein the server is configured to determine a location for each of the plurality of customers and to push the notification out to the plurality of customers based on the determined location for each of the plurality of customers.

12. The system of claim 1, wherein the server is further configured to upload contact information for a customer and to send invitations to the customer's contacts to register with the server using the contact information.

13. The system of claim 13, wherein the server is configured to seek permission from the customer before sending invitations.

14. The system of claim 1, wherein the server is further configured to receive a communication via the communication interface that includes a device identifier associated with a customer and a code associated with one of the plurality of businesses from a customer, register the customer using the device identifier, and associate the customer with services offered by the business.
